(19) United States
(12) Patent Application Publication
(10) Pub. No.: US 2005/0040616 A1
(43) Pub. Date: Feb. 24, 2005

(54) GOLF BAG CART

(76) Inventor: Dar-Hsiang Cheng, Tainan City (TW)

Correspondence Address: Dar-Hsiang Cheng, P.O. Box 90, Tainan City, 704, TW

(21) Appl. No.: 10/642,334

(22) Filed: Aug. 18, 2003

(51) Int. Cl. B62B 1/00; B62B 7/02

(52) U.S. Cl. 280/47.24

(57) ABSTRACT

A golf bag cart in the invention includes a main wheel frame having a motor and a connecting base; a front wheel frame assembled in front of the main wheel frame; a main rod pivoted with the connecting base; a slide sleeve fitted around the main rod and capable of being sleeved on the connecting base; a support bracket pivotally mounted on the main rod for supporting a golf bag and capable of being folded; a telescopic rod inserted into the main rod and capable of being pulled outwardly or withdrawn into the main rod; and, a grip handle disposed at an upper end of the telescopic rod and having an ON/OFF button and a speed-adjustment knob connected with the motor via power-supply cords, whereby the golf bag cart is constructed, prompt in assembling, easy and labor-saving in operation, simple in collapsing, and utility and convenient in use.

### BACKGROUND OF THE INVENTION

1. Field of the Invention

This invention relates to a golf bag cart, particularly to one having a main wheel frame provided with a motor and a connecting base; a front wheel frame assembled in front of the main wheel frame; a main rod pivoted with the connecting base of the main wheel frame; a slide sleeve fitted around the main rod and capable of being correspondingly sleeved on the connecting base of the main wheel frame; a support bracket pivotally mounted on the main rod for supporting a golf bag and capable of being folded; a telescopic rod inserted into the main rod and capable of being pulled outwardly or withdrawn into the main rod; and, a grip handle disposed at an upper end of the telescopic rod and provided with an ON/OFF button and a speed-adjustment knob disposed thereon and connected with the motor of the main wheel frame via power-supply cords, whereby the golf bag cart of the present invention is constructed, which is prompt in assembling, easy and labor-saving in operation, simple in collapsing, and utility and convenient in use.

2. Description of the Prior Art

Generally speaking, a known conventional golf bag cart 1, as shown in FIG. 1, has a front wheel frame 10, a lower support bracket 11 disposed above the front wheel frame 10, a dual main frame 12 extending upwardly behind the front wheel frame 10, an upper bracket 13 in curved shape and disposed at an upper end of the dual main frame 12, a rear wheel frame 14 connected under the upper bracket 13, a grip handle 15 connected behind the upper bracket 13 and inclined upwardly, and two reinforced ribs 16 disposed between the dual main frame 12 and the rear wheel frame 14. The front wheel frame 10 has two front wheels 100 respectively coupled at both sides thereof; the rear wheel frame 14 has a rear wheel 140 pivotally coupled at a bottom thereof. The golf bag cart 1 is adapted to support a golf bag and convenient for a user to transport the gold bag by pushing the golf bag cart 1 forward with laborsaving operation.

Although a user can transport the golf bag by the known golf bag cart 1 without carrying it on his back; however, the user still has to take a lot of strength to push or pull the golf bag cart 1 with hard work because the golf bag cart 1 with heavy weight is moved on the uneven ground of a golf course. Moreover, the golf bag cart 1 occupies relatively large space and inconvenient for transportation when not in use.

### SUMMARY OF THE INVENTION

The main purpose of the present invention is to offer a golf bag cart, which is prompt in assembling, easy and labor-saving in operation and simple in collapsing.

One primary feature of the present invention is to provide a golf bag cart mainly including:
a main wheel frame having two main wheels respectively coupled at both sides thereof;
a front wheel frame located in front of the main wheel frame and having at least one front wheel coupled thereto;
a main rod capable of being combined with the main wheel frame at one end thereof and having at least one positioning hole disposed in an appropriate place thereof;
a support bracket capable of being combined with the main rod for supporting a golf bag;
a telescopic rod capable of being inserted into the main rod and having a through hole disposed in a sidewall near a bottom thereof, a link rod disposed therein and longitudinally extending therethrough, a slide block secured at a bottom of the link rod and an insertion member inserted into the bottom thereof to prevent the link rod from slipping out of the bottom of the telescopic rod, the link rod provided with a press block disposed at a top thereof, the slide block provided with a sliding groove and a cavity at one side surface thereof, a ball confined and slidable between the sliding groove and the cavity of the slide block for being correspondingly engaged with the through hole of the telescopic rod and any one of the positioning holes of the main rod to fix the telescopic rod in position, a spring disposed above the insertion member with one end pressed downwardly against the insertion member and the other end pressed upwardly against a bottom of the slide block; and,
a grip handle disposed at an upper end of the telescopic rod and having an aperture disposed therein for protrusion of the press block of the telescopic rod.

One another feature of the present invention is to provide a golf bag cart mainly including:
a main wheel frame having two main wheels respectively coupled at both sides thereof;
a front wheel frame located in front of the main wheel frame and having at least one front wheel coupled thereto;
a main rod capable of being combined with the main wheel frame at one end thereof and having a pivot block fixedly secured to an upper portion thereof, the pivot block provided with a pair of opposite first engagement holes and a pair of opposite second engagement holes disposed therein;
a support bracket capable of being pivotally mounted on the pivot block of the main rod and having a front portion designed to be a supporting part for supporting a golf bag and a rear portion provided with an elastic member disposed therein as well as two opposite through holes respectively disposed in both sidewalls thereof, the elastic member provided with two projecting bosses respectively disposed adjacent both ends thereof and capable of being protruded out of the two opposite through holes of the rear portion of the support bracket for being correspondingly engaged with the pair of opposite first engagement holes or the pair of opposite second engagement holes of the pivot block of the main rod; and,
a grip handle disposed at an upper end of the main rod.

One further feature of the invention is to provide a golf bag cart mainly including:
a main wheel frame having two main wheels respectively coupled at both sides thereof and a connecting base disposed in an appropriate place thereof, the connecting base provided with an insertion piece disposed thereon, the insertion piece provided with two sloped edges respectively formed at both sides thereof;
a front wheel frame located in front of the main wheel frame and having at least one front wheel coupled thereto;
a main rod capable of being pivoted with the connecting base of the main wheel frame at one end thereof;
a slide sleeve fitted around the main rod and capable of being correspondingly sleeved on the connecting base of the main wheel frame, the slide sleeve having a bore disposed at a front portion for being inserted by the main rod and an insertion hole disposed at a rear portion in a position corresponding to the insertion piece of the connecting base, the insertion hole provided with two sloped edges respectively formed at both inner sidewalls thereof and corresponding to the two sloped edges of the insertion piece of the connecting base;
a support bracket capable of being combined with the main rod for supporting a golf bag; and,
a grip handle disposed at an upper end of the main rod.

### BRIEF DESCRIPTION OF DRAWINGS

This invention will be better understood by referring to the accompanying drawings, wherein:

FIG. 1 is a perspective view of a known conventional golf bag cart;

FIG. 2 is a perspective view of a golf bag cart in the present invention;

FIG. 3 is an exploded perspective view of a part of the golf bag cart in the present invention;

FIG. 4 is a sectional view of the golf bag cart in the present invention, showing the structure of an insertion hole of a slide sleeve and the structure of an insertion piece of a connecting base;

FIG. 5 is a schematic view in partial section of a support bracket of the golf bag cart in the present invention;

FIG. 6 is an exploded perspective view of a telescopic rod of the golf bag cart in the present invention;

FIG. 7 is sectional schematic view of the golf bag cart in the present invention, showing the telescopic rod being held in position;

FIG. 8 is sectional schematic view of the golf bag cart in the present invention, showing the telescopic rod being released to move telescopically; and,

FIG. 9 is a perspective view of the golf bag cart in the present invention in a collapsed condition.

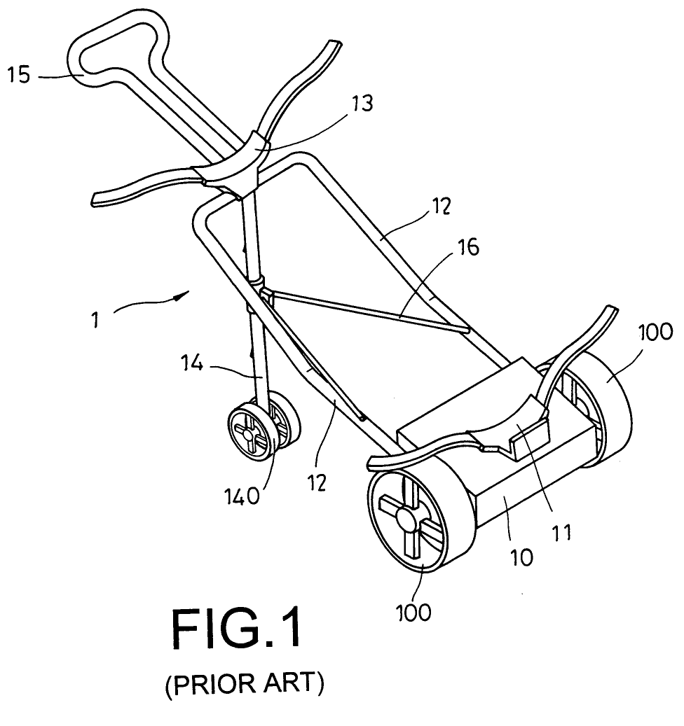

### DETAILED DESCRIPTION OF THE PREFERRED EMBODIMENT

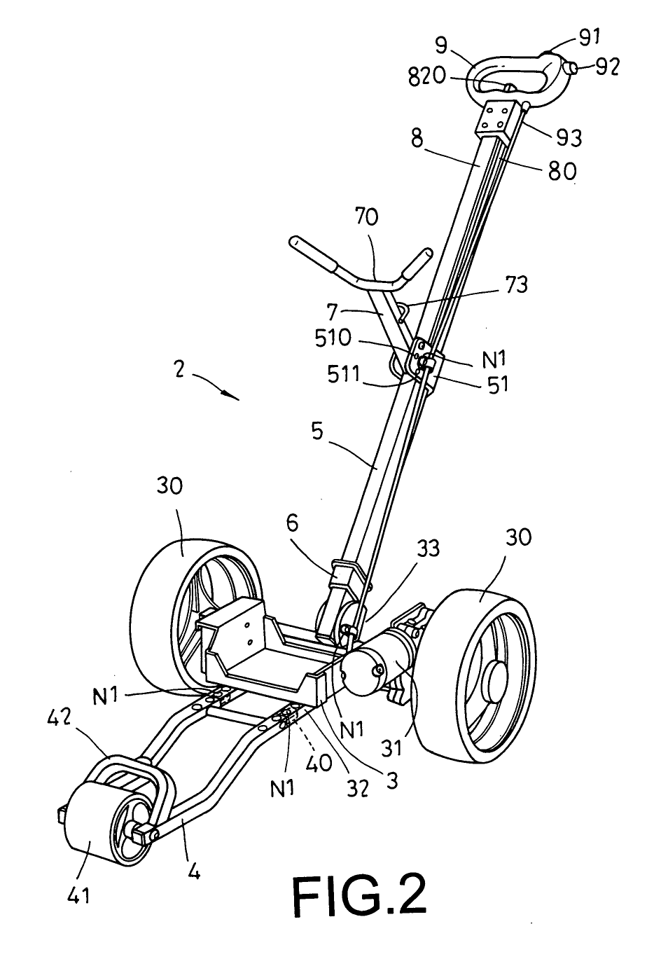

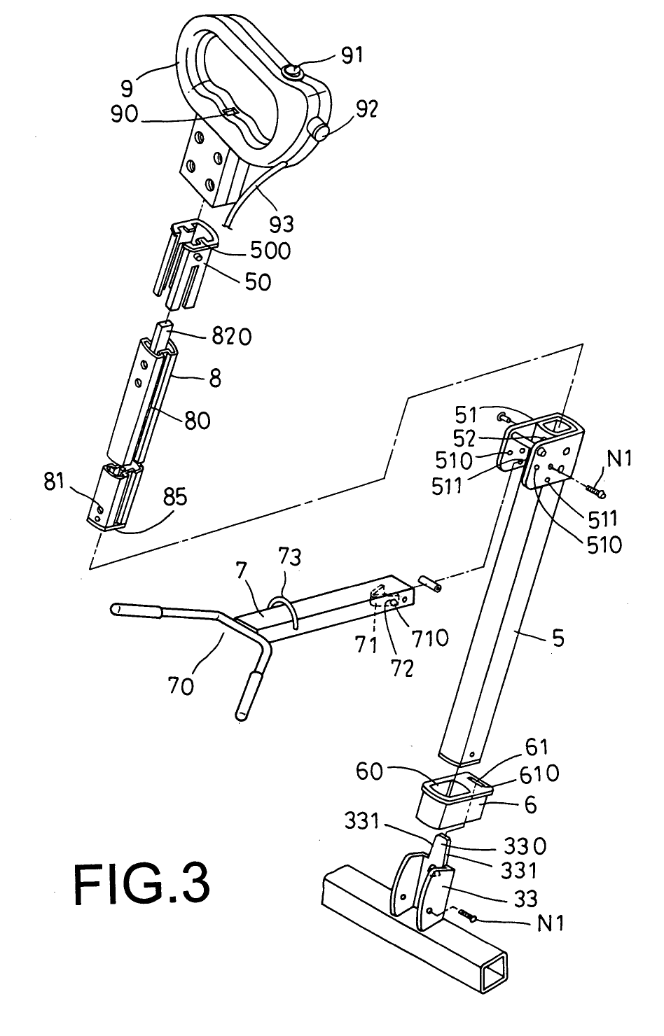

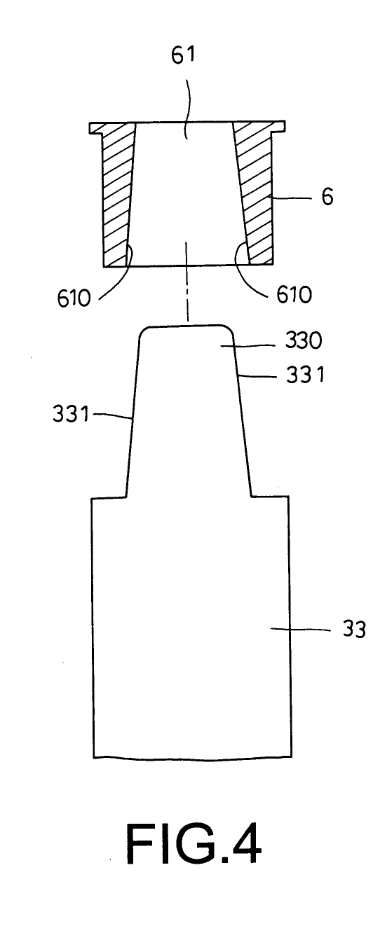

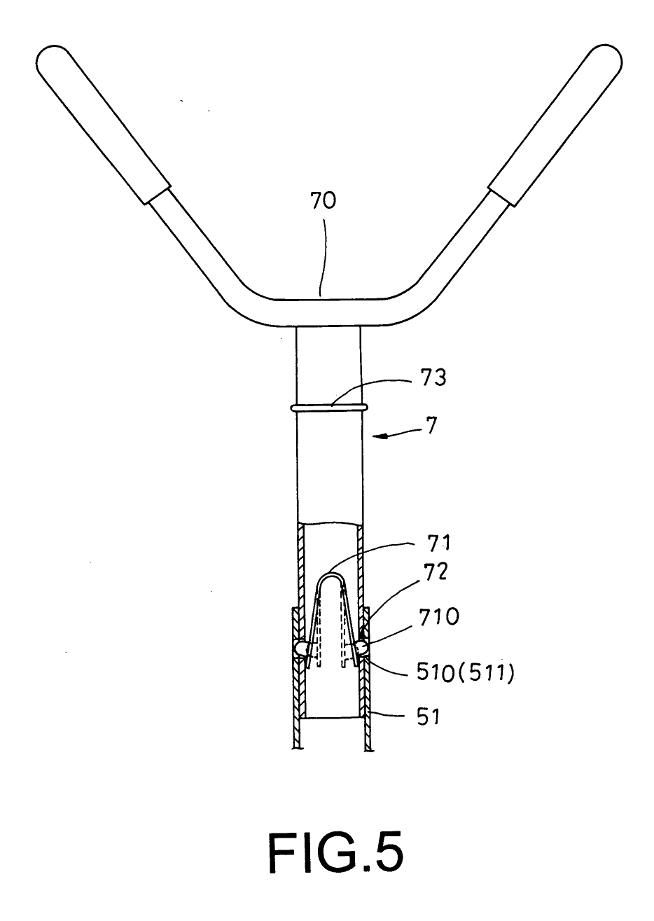

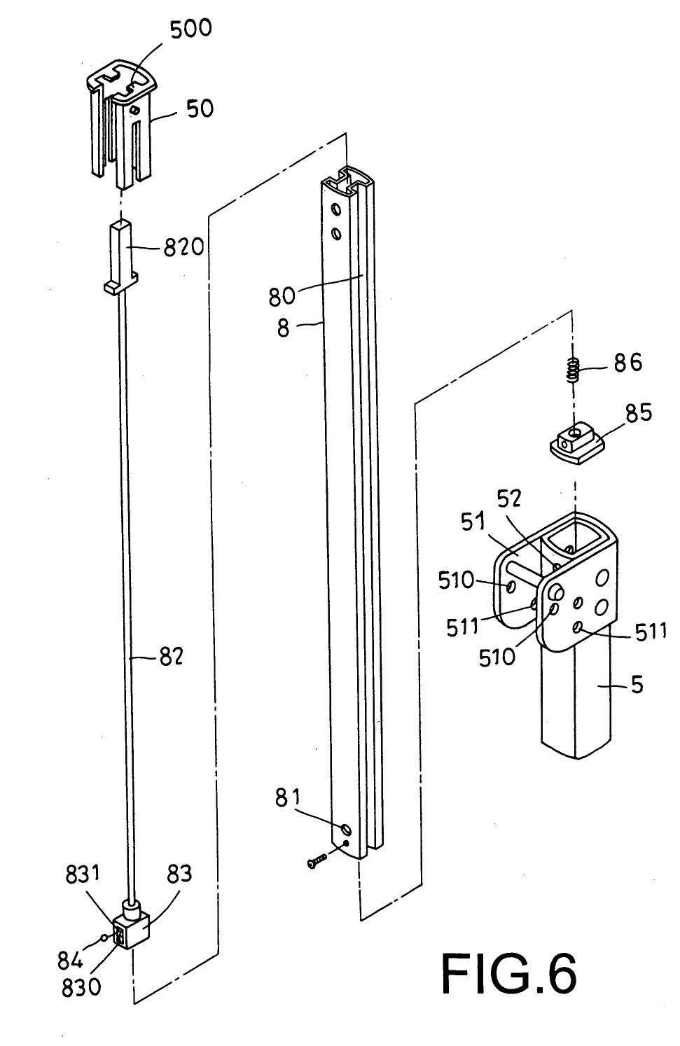

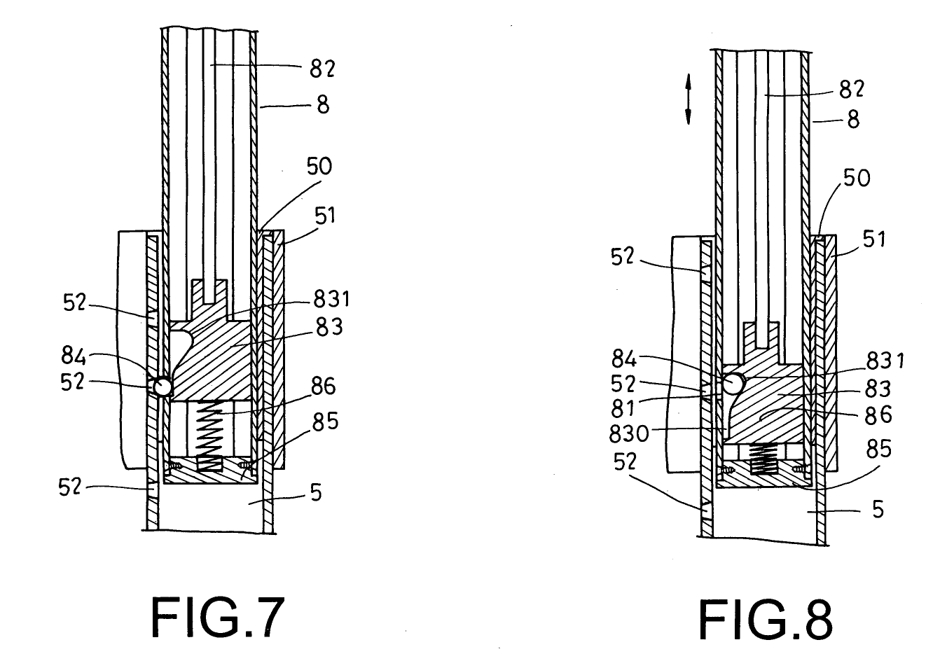

A preferred embodiment of a golf bag cart 2 in the present invention, as shown in FIGS. 2 to 8, mainly includes a main wheel frame 3, a front wheel frame 4, a main rod 5, a slide sleeve 6, a support bracket 7, a telescopic rod 8 and a grip handle 9.

The main wheel frame 3 disposed at a lower portion of the golf bag cart 2 has two main wheels 30 respectively coupled at both sides thereof and a motor 31 mounted on an appropriate place between the two main wheels 30 for supply power to drive the two main wheels 30 to rotate. The two main wheels 30 are limited to move forward only in one way without moving backward reversely; therefore, only to place the golf bag cart 2 in a reversing direction, and then the golf bag cart 2 can be parked securely. The main wheel frame 3 further has two coupling parts 32 disposed at a front portion thereof and a connecting base 33 disposed in an appropriate place of a center adjacent a rear portion thereof. An insertion piece 330 disposed on the connecting base 33 is provided with two sloped edges 331 respectively formed at both sides thereof and gradually becoming narrower from its bottom to its top.

The front wheel frame 4 capable of being assembled with the main wheel frame 3 has two coupling parts 40 disposed at a rear portion thereof for being combined with the two coupling parts 32 of the main wheel frame 3 by screw members N1. The front wheel frame 4 further has a front wheel 41 pivotally connected to a front portion thereof and a support stand 42 disposed above the front wheel 41 for supporting a bottom of a golf bag (not numbered).

The main rod 5 capable of being mounted with the connecting base 33 of the main wheel frame 3 at one end thereof by screw members N1 has a stop member 50 fitted in an upper end thereof, a [symbol] -shaped pivot block 51 fixedly secured to an upper portion thereof, and a plurality of positioning holes 52 disposed in the upper portion thereof. The stop member 50 is provided with two stopping projections 500 disposed therein. The pivot block 51 is provided with a pair of opposite first engagement holes 510 and a pair of opposite second engagement holes 511 disposed therein.

The slide sleeve 6 is fitted around the main rod 5 and capable of being correspondingly sleeved on the connecting base 33 of the main wheel frame 3 for facilitating the main rod 5 to be erected stably. The slide sleeve 6 has a bore 60 disposed at a front portion for being inserted by the main rod 5 and an insertion hole 61 disposed at a rear portion in a position corresponding to the insertion piece 330 of the connecting base 33. The insertion hole 61 is provided with two sloped edges 610 respectively formed at both inner sidewalls thereof and gradually becoming narrower from its bottom to its top for corresponding to the two sloped edges 331 of the insertion piece 330 of the connecting base 33.

The support bracket 7 capable of being pivotally mounted on the pivot block 51 of the main rod 5 has a front portion designed to be an approximately Y-shaped supporting part 70, and a rear portion provided with an approximately U-shaped elastic member 71 disposed therein as well as two opposite through holes 72 respectively disposed in both sidewalls thereof. The elastic member 71 is provided with two projecting bosses 710 respectively disposed adjacent both ends thereof and capable of being protruded out of the two opposite through holes 72 of the rear portion of the support bracket 7 for being correspondingly engaged with the pair of opposite first engagement holes 510 or the pair of opposite second engagement holes 511 of the pivot block 51 of the main rod 5 to allow the support bracket 7 to be quickly fixed in an unfolding position or in a folded position, which is very easy and laborsaving in operation. The support bracket 7 further has a retaining link 73 disposed in an appropriate place thereof for being retained by a strap (not numbered) to fasten the golf bag that is supported by the support bracket 7 securely in position.

The telescopic rod 8 capable of being inserted into the main rod 5 and defined a hollow space disposed in an interior thereof has two grooves 80 respectively disposed at outer surfaces of two opposite sides thereof, a through hole 81 disposed in a sidewall near a bottom thereof, a link rod 82 disposed therein and longitudinally extending therethrough, a slide block 83 secured to a bottom of the link rod 82, and an insertion member 85 inserted into the bottom thereof to prevent the link rod 82 from slipping out of the bottom of the telescopic rod 8. The link rod 82 is provided with a press block 820 disposed at a top thereof. The slide block 83 is provided with a sliding groove 830 disposed in one side surface thereof corresponding to the through hole 81, and a cavity 831 disposed at one end of the sliding groove 830 with a thickness thicker than that of the sliding groove 830. A ball 84 is confined and slidable between the sliding groove 830 and the cavity 831 of the slide block 83 for being correspondingly engaged with the through hole 81 and any one of the positioning holes 52 of the main rod 5 to fix the telescopic rod 8 in position. A spring 86 is disposed above the insertion member 85 with one end pressed downwardly against the insertion member 85 and the other end pressed upwardly against a bottom of the slide block 83.

The grip handle 9 assembled at an upper end of the telescopic rod 8 has an aperture 90 disposed therein for protrusion of the press block 820 of the telescopic rod 8. The grip handle 9 further has an ON/OFF button 91 and a speed-adjustment knob 92 disposed thereon and connected with the motor 31 of the main wheel frame 3 via power-supply cords 93.

In assembling, referring to FIGS. 2 to 8, firstly assemble the two coupling parts 40 of the front wheel frame 4 with the two coupling parts 32 of the main wheel frame 3 by the screw members N1. Secondly, insert the insertion member 85 that is fitted around by the spring 86 into the bottom of the telescopic rod 8, and then screw the insertion member 85 with the telescopic rod 8 securely. Thirdly, extend one end of the link rod 82 that is secured with the slide block 83 longitudinally into the telescopic rod 8 with one side of the link rod 82 that is provided with the sliding groove 830 and the cavity 831 therein corresponding to one side of the telescopic rod 8 that is provided with the through hole 81 therein, depress the press block 820 disposed at the top of the link rod 82 slightly downwardly to make the cavity 831 aligned with the through hole 81, and then bring the ball 84 to be accommodated in the cavity 831. Fourthly, insert the telescopic rod 8 into the main rod 5 with one side of the telescopic rod 8 that is provided with the through hole 81 therein corresponding to one side of the main rod 5 that is provided with the plurality of positioning holes 52 therein, and then fit the stop member 50 in an upper end of the main rod 5 with the two stopping projections 500 of the stop member 50 respectively corresponding to the two grooves 80 of the telescopic rod 8 so that the telescopic rod 8 is capable of sliding in the main rod 5 and the insertion member 85 of the telescopic rod 8 can be stopped by the two stopping projections 500 of the stop member 50 so as to prevent the telescopic rod 8 from slipping out of the upper end of the main rod 5 when the telescopic rod 8 is pulled upwardly. Fifthly, assemble the grip handle 9 on the upper end of the telescopic rod 8 with the press block 820 of the telescopic rod 8 protruded out of the aperture 90 of the grip handle 9, and then screw the grip handle 9 with the upper end of the telescopic rod 8 securely. Sixthly, pivotally combine the support bracket 7 with the main rod 5 with the Y-shaped supporting part 70 of the support bracket 7 oriented forward and with the rear end of the support bracket 7 pivoted with the pivot block 51 of the main rod 5 by the screw members N1. Finally, fit the bore 60 of the slide sleeve 6 around the main rod 5, extend a lower end of the main rod 5 into the connecting base 33 of the main wheel frame 3 to be pivoted with the connecting base 33 by the screw members N1, and then correspondingly sleeve the insertion hole 61 of the slide sleeve 6 on the insertion piece 330 of the connecting base 33, by which an assemblage of the whole structure of the golf bag cart 2 in the present invention is completed.

In using, referring to FIGS. 2 to 5, 7 and 8, firstly make the main rod 5 stand erect, and then move the slide sleeve 6 downward to make the insertion hole 61 of the slide sleeve 6 correspondingly sleeved on the insertion piece 330 of the connecting base 33 so as to make the main rod 5 erected stably in position. Secondly, displace the support bracket 7 upward to make the two projecting bosses 710 of the elastic member 71 correspondingly engaged with the pair of opposite first engagement holes 510 of the pivot block 51 of the main rod 5 to make the support bracket 7 quickly fixed in an unfolding position for supporting a golf bag. Thirdly, pull the telescopic rod 8 upwardly until the through hole 81 of the telescopic rod 8 is aligned to one of the positioning holes 52 of the main rod 5 according to a desired height of the telescopic rod 8. At this time, the ball 84 accommodated in the cavity 831 of the slide block 83 is forced to slide into the sliding groove 830 of the slide block 83 when the slide block 83 is urged upward under the resilience of the spring 86, and is just to be correspondingly engaged with the through hole 81 of the telescopic rod 8 and the selected one of the positioning holes 52 of the main rod 5 so as to fix the telescopic rod 8 in position.

When the golf bag cart 2 is to be moved forward, only to depress the ON/OFF button 91 to actuate the motor 31 of the main wheel frame 3 to drive the two main wheels 30 to rotate, and adjust the speed-adjustment knob 92 to make the golf bag cart 2 move at a desired speed, thus enabling the golf bag cart 2 to move forward automatically without any toil in manually pushing or pulling the golf bag cart 2.

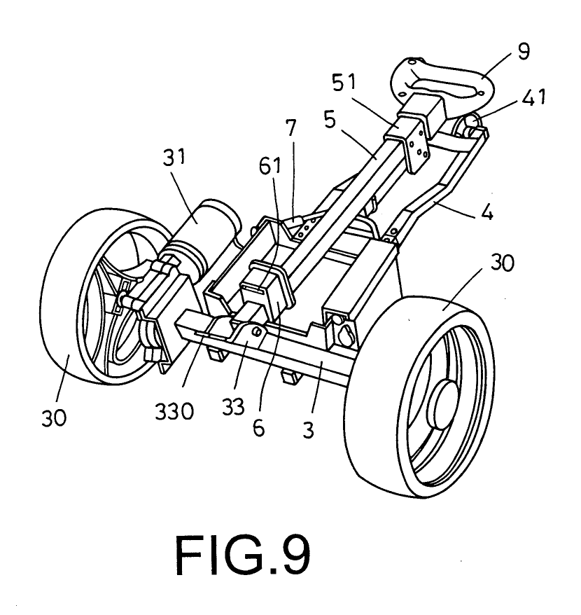

When the golf bag cart 2 is to be collapsed, referring to FIGS. 2 to 5, and 7 to 9, firstly only to depress the press block 820 of the telescopic rod 8 to force the link rod 82 to lower the slide block 83 to compress the spring 86 to make the ball 84 sliding into the cavity 831 of the slide block 83 so that the ball 84 can be disengaged from the through hole 81 of the telescopic rod 8 and the selected one of the positioning holes 52 of the main rod 5, and then push the grip handle 9 slightly downwardly to make the telescopic rod 8 withdrawn into the main rod 5. Secondly, push the support bracket 7 downwardly to make the two projecting bosses 710 of the elastic member 71 disengaged from the pair of opposite first engagement holes 510 of the pivot block 51, and further displace the support bracket 7 to make the two projecting bosses 710 correspondingly engaged with the pair of opposite second engagement holes 511 of the pivot block 51 so as to make the support bracket 7 folded in a fixed position. Finally, pull the slide sleeve 6 upwardly to be disconnected with the insertion piece 330 of the connecting base 33, and then press the main rod 5 forward with a pivotal connected point of the main rod 5 and the connecting base 33 functioned as a pivot, thereby collapsing the golf bag cart 2 quickly, as shown in FIG. 9.

The invention has the following advantages, as can be understood from the aforesaid description.

1. The plurality of positioning holes 52 disposed in the upper portion of the main rod 5 enables the telescopic rod 8 to be adjusted to and fixed at a desired height according to the individual need of each user, which is easy and convenient in adjusting the telescopic rod 8 to various heights.

2. The assembling of the two coupling parts 40 of the front wheel frame 4 with the two coupling parts 32 of the main wheel frame 3 by the screw members N1 enabled the front wheel frame 4 to be disassembled with the main wheel frame 3 easily and conveniently, thus minimizing the whole dimension of the golf bag cart 2 after being collapsed and reducing the volume in packing, which is convenient for transportation and storage.

3. The corresponding sloping relationship in the sloped edges 331 of the insertion piece 330 of the connecting base 33 with its top narrower than its bottom and the sloped edges 610 of the insertion hole 61 of the slide sleeve 6 also with its top narrower than its bottom enables the insertion hole 61 to be easily aligned with the insertion piece 330 in their central axes and quickly sleeved on the insertion piece 330 with better tightness for facilitating the main rod 5 to be erected stably. Moreover, after long-termed use, the insertion hole 61 will not become larger with much more allowance to cause loose joint.

4. The support bracket 7 can be quickly fixed in an unfolding position or in a folded position by making the two projecting bosses 710 of the elastic member 71 correspondingly engaged with the pair of opposite first engagement holes 510 or the pair of opposite second engagement holes 511 of the pivot block 51 of the main rod 5, which is easy and laborsaving in operation.

5. The retaining link 73 disposed in an appropriate place of the support bracket 7 can be retained by a strap to fasten a golf bag that is supported by the support bracket 7 securely in position.

6. When the telescopic rod 8 is to be withdrawn, only to depress the press block 820 of the telescopic rod 8 to force the link rod 82 to lower the slide block 83 to make the ball 84 sliding into the cavity 831 of the slide block 83 so that the ball 84 can be disengaged from the through hole 81 of the telescopic rod 8 and the selected one of the positioning holes 52 of the main rod 5, thereby withdrawing the telescopic rod 8 into the main rod 5 quickly.

7. When the golf bag cart 2 is to be moved forward, only to depress the ON/OFF button 91 to actuate the motor 31 of the main wheel frame 3 to drive the two main wheels 30 to rotate, and then adjust the speed-adjustment knob 92 to make the golf bag cart 2 move at a desired speed, thus enabling the golf bag cart 2 to move forward automatically without any toil in manually pushing or pulling the golf bag cart 2, which is simple and easy in operation.

8. The golf bag cart 2 in the invention is prompt in assembling, easy and laborsaving in operation, simple in collapsing, and utility and convenient in use.

While the preferred embodiment of the invention has been described above, it will be recognized and understood that various modifications may be made therein and the appended claims are intended to cover all such modifications that may fall within the spirit and scope of the invention.

1. A golf bag cart comprising:
a main wheel frame having two main wheels respectively coupled at both sides thereof;
a front wheel frame located in front of said main wheel frame and having at least one front wheel coupled thereto;
a main rod capable of being combined with said main wheel frame at one end thereof and having at least one positioning hole disposed in an appropriate place thereof;
a support bracket capable of being combined with said main rod for supporting a golf bag;
a telescopic rod capable of being inserted into said main rod and having a through hole disposed in a sidewall near a bottom thereof, a link rod disposed therein and longitudinally extending therethrough, a slide block secured at a bottom of said link rod and an insertion member inserted into said bottom thereof to prevent said link rod from slipping out of said bottom of said telescopic rod, said link rod provided with a press block disposed at a top thereof, said slide block provided with a sliding groove and a cavity at one side surface thereof, a ball confined and slidable between said sliding groove and said cavity of said slide block for being correspondingly engaged with said through hole of said telescopic rod and any one of said positioning holes of said main rod to fix said telescopic rod in position, a spring disposed above said insertion member with one end pressed downwardly against said insertion member and the other end pressed upwardly against a bottom of said slide block;
a grip handle disposed at an upper end of said telescopic rod and having an aperture disposed therein for protrusion of said press block of said telescopic rod; and,
whereby said golf bag cart is constructed, and only to depress said press block of said telescopic rod to force said link rod to lower said slide block to make said ball sliding into said cavity of said slide block so that said ball can be disengaged from said through hole of said telescopic rod and any one of said positioning holes of said main rod to allow said telescopic rod to be pulled outwardly or withdrawn into said main rod quickly.

2. A golf bag cart comprising:
a main wheel frame having two main wheels respectively coupled at both sides thereof;
a front wheel frame located in front of said main wheel frame and having at least one front wheel coupled thereto;
a main rod capable of being combined with said main wheel frame at one end thereof and having a pivot block fixedly secured to an upper portion thereof, said pivot block provided with a pair of opposite first engagement holes and a pair of opposite second engagement holes disposed therein;
a support bracket capable of being pivotally mounted on said pivot block of said main rod and having a front portion designed to be a supporting part for supporting a golf bag and a rear portion provided with an elastic member disposed therein as well as two opposite through holes respectively disposed in both sidewalls thereof, said elastic member provided with two projecting bosses respectively disposed adjacent both ends thereof and capable of being protruded out of said two opposite through holes of said rear portion of said support bracket for being correspondingly engaged with said pair of opposite first engagement holes or said pair of opposite second engagement holes of said pivot block of said main rod;
a grip handle disposed at an upper end of said main rod; and,
whereby said golf bag cart is constructed, and said support bracket can be quickly fixed in an unfolding position or in a folded position when said support bracket is displaced to make said two projecting bosses of said elastic member correspondingly engaged with said pair of opposite first engagement holes or said pair of opposite second engagement holes of said pivot block of said main rod, which is easy and laborsaving in operation.

3. A golf bag cart comprising:
a main wheel frame having two main wheels respectively coupled at both sides thereof and a connecting base disposed in an appropriate place thereof, said connecting base provided with an insertion piece disposed thereon, said insertion piece provided with two sloped edges respectively formed at both sides thereof;
a front wheel frame located in front of said main wheel frame and having at least one front wheel coupled thereto;
a main rod capable of being pivoted with said connecting base of said main wheel frame at one end thereof;
a slide sleeve fitted around said main rod and capable of being correspondingly sleeved on said connecting base of said main wheel frame, said slide sleeve having a bore disposed at a front portion for being inserted by said main rod and an insertion hole disposed at a rear portion in a position corresponding to said insertion piece of said connecting base, said insertion hole provided with two sloped edges respectively formed at both inner sidewalls thereof and corresponding to said two sloped edges of said insertion piece of said connecting base;
a support bracket capable of being combined with said main rod for supporting a golf bag;
a grip handle disposed at an upper end of said main rod; and,
whereby said golf bag cart is constructed, and the corresponding sloping relationship in said sloped edges of said insertion hole of said slide sleeve and said sloped edges of said insertion piece of said connecting base enables said insertion hole to be easily aligned with said insertion piece in their central axes and quickly sleeved on said insertion piece with better tightness for facilitating said main rod to be erected stably.

4. The golf bag cart as claimed in claim 1, 2 or 3, wherein said main wheel frame is provided with at least one coupling part disposed at a front portion thereof, and said front wheel frame is provided with at least one coupling part for being combined with said at least one coupling part of said main wheel frame by screw members, whereby said front wheel frame can be easily disassembled with said main wheel frame, convenient for transportation and storage.

5. The golf bag cart as claimed in claim 1, 2 or 3, wherein said main wheel frame has a motor mounted thereon for driving said two main wheels to rotate, and said grip handle is provided with an ON/OFF button and a speed-adjustment knob disposed thereon and connected with said motor of said main wheel frame via power-supply cords for convenience of controlling said motor.

6. The golf bag cart as claimed in claim 1, 2 or 3, wherein said support bracket has a retaining link disposed in an appropriate place thereof for being retained by a strap to fasten a golf bag that is supported by said support bracket securely in position.

7. The golf bag cart as claimed in claim 1, wherein said main rod has a stop member fitted in an upper end thereof and provided with at least one stopping projection for stopping said insertion member that is inserted into said bottom of said telescopic rod so as to prevent said telescopic rod from slipping out of said upper end of said main rod when said telescopic rod is pulled upwardly.
